(19) United States
(12) Patent Application Publication
(10) Pub. No.: US 2026/0341582 A1
(43) Pub. Date: Oct. 29, 2026

(54) FILTER

(71) Applicant: TAI-TECH ADVANCED ELECTRONICS CO., LTD., Taoyuan City (TW)

(72) Inventors: Yu-You HUANG, Taoyuan City (TW); Cheng-Han YU, Taoyuan City (TW); Pao-Lin SHEN, Taoyuan City (TW); Ming-Yen HSIEH, Taoyuan City (TW)

(21) Appl. No.: 19/192,396

(22) Filed: Apr. 29, 2025

(51) Int. Cl. H01F 27/28; H01F 27/02; H01F 27/08; H01F 27/32

(52) U.S. Cl. CPC H01F 27/2852; H01F 27/022; H01F 27/025; H01F 27/08; H01F 27/323

(57) ABSTRACT

The filter includes a body and at least a coil assembly. The body is defined with a first surface. The coil assembly is defined with a second surface. The coil assembly is enclosed in the body with the second surface parallel to the first surface. The coil assembly includes a first coil, a second coil, and an insulator. Two ends of the first and second coils are respectively bent perpendicularly to form first and second terminals. The first terminals and second terminals are extended in a same direction. The insulator is configured between the first and second coils with the first coil stacking above a top side of the second coil. As a result, the coil assembly is arranged laterally in the body, and the first and second coils of the coil assembly are stacked together, thereby reducing the overall height and meeting the requirements for a low-profile design.

### BACKGROUND OF THE INVENTION

### (a) Technical Field of the Invention

The present invention generally relates to filters, and more particularly to a low-profile filter.

### (b) Description of the Prior Art

As shown in FIGS. 7 and 7A, a conventional filter includes a body 3 and a coil assembly 4, with the coil assembly 4 installed inside the body 3. The body 3 defines a first surface 30, and the coil assembly 4 defines a second surface 40, which is perpendicular to the first surface 30. The coil assembly 4 includes a first coil 41 and a second coil 42 stacked on top of each other.

As shown in FIG. 7B, since the coil assembly 4 of the conventional filter is vertically mounted on the body 3, the overall height H1 of the filter when mounted on a printed circuit board (PCB) 50 is relatively high. However, the increased height of the conventional filter leads to the following issues:
1. Reduced stability: Because the coil assembly 4 is vertically mounted on the body 3, the center of gravity is higher, making it more prone to shaking or detachment under mechanical vibration or impact.
2. Larger space consumption: Although the conventional filter occupies a smaller footprint on the PCB, its greater height may affect the overall product design, especially in space-constrained applications.
3. More difficult to automate production: Conventional filters typically require manual soldering or special insertion machines, which impacts production efficiency and increases manufacturing costs.

### SUMMARY OF THE INVENTION

To overcome the above shortcomings, the present invention discloses a filer including a body and at least a coil assembly. The body is defined with a first surface. The coil assembly is defined with a second surface. The coil assembly is enclosed in the body with the second surface parallel to the first surface. The coil assembly includes a first coil, a second coil, and an insulator. Two ends of the first and second coils are respectively bent perpendicularly to form first and second terminals. The first terminals and second terminals are extended in a same direction. The insulator is configured between the first and second coils with the first coil stacking above a top side of the second coil.

Specifically, the first and second coils are flat coils.

Specifically, at least one heat dissipating piece is configured on the body's exterior.

Specifically, when there are two or more coil assemblies, the coil assemblies are arranged laterally with equal spacing.

Specifically, the body includes a base portion and a cover portion.

As a result, the coil assembly is arranged laterally in the body, and the first and second coils of the coil assembly are stacked together, thereby reducing the overall height and meeting the requirements for a low-profile design.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective see-through diagram showing a filter according to an embodiment of the present invention.

FIG. 2 is a perspective break-down diagram showing the filter of FIG. 1.

FIG. 3 is a perspective break-down diagram showing a coil assembly of the filter of FIG. 1.

FIG. 4 is a perspective see-through diagram showing a filter according to an embodiment of the present invention which includes three coil assemblies.

FIG. 5 is a perspective see-through diagram showing a filter according to an embodiment of the present with heat dissipating pieces attached to the body.

FIG. 5A is a schematic front-view diagram showing a filter according to an embodiment of the present with heat dissipating pieces attached to the body.

FIG. 6 is a schematic sectional diagram showing the filter of FIG. 1.

FIG. 6A is a schematic sectional diagram showing the filter of FIG. 1. mounted on a circuit board.

FIG. 7 is a front-view see-through diagram of a conventional filter.

FIG. 7A is a side-view see-through diagram of the conventional filter of FIG. 7.

FIG. 7B is another side-view see-through diagram of the conventional filter of FIG. 7 mounted on a circuit board.

FIG. 8 is a diagram showing test data of a conventional filter and a filter according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

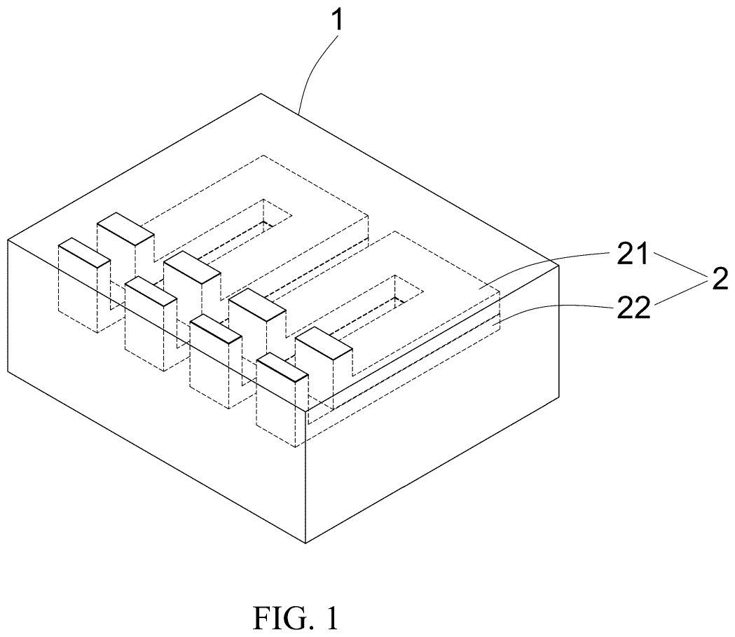

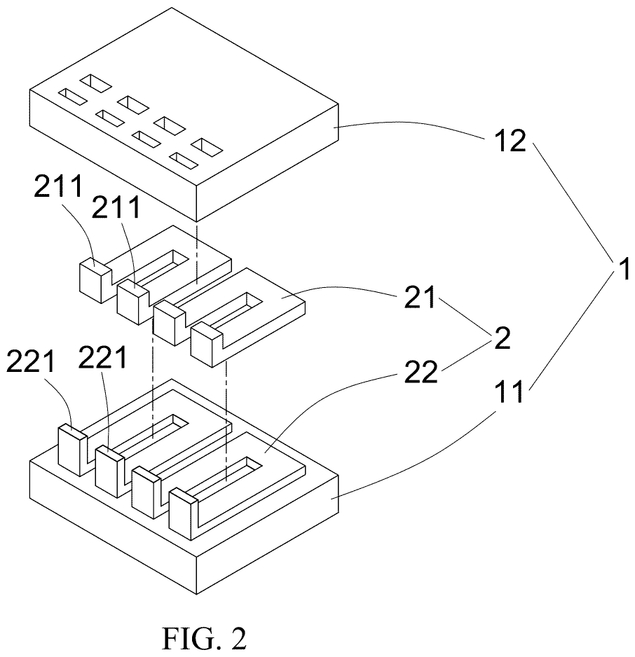

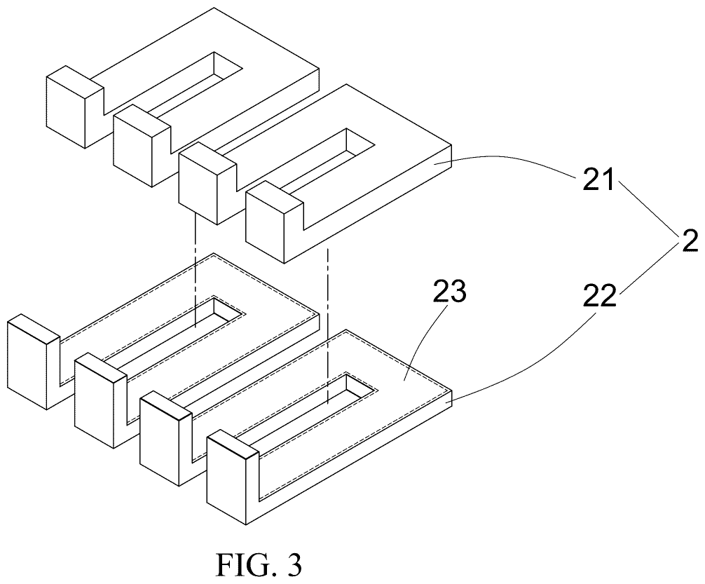

As shown in FIGS. 1 to 3, a filter according to an embodiment of the present invention includes the following components.

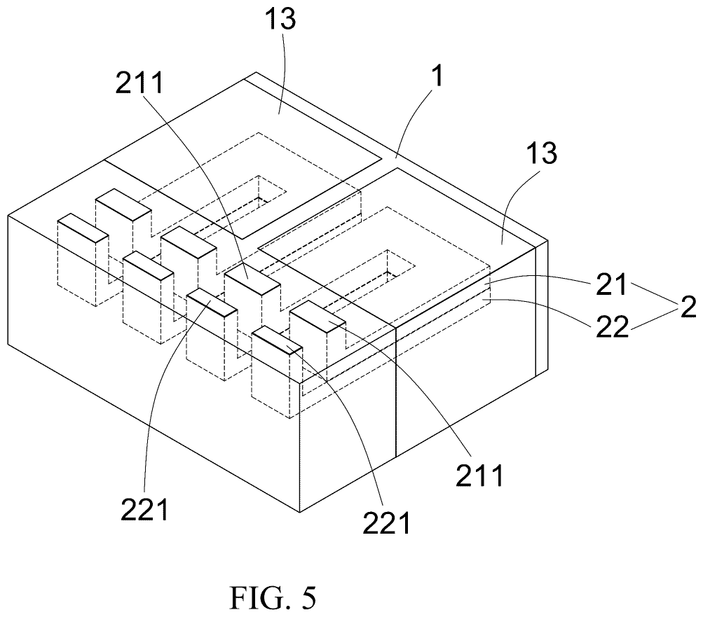

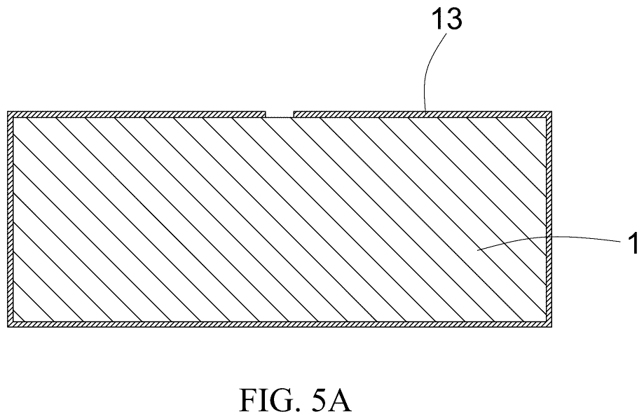

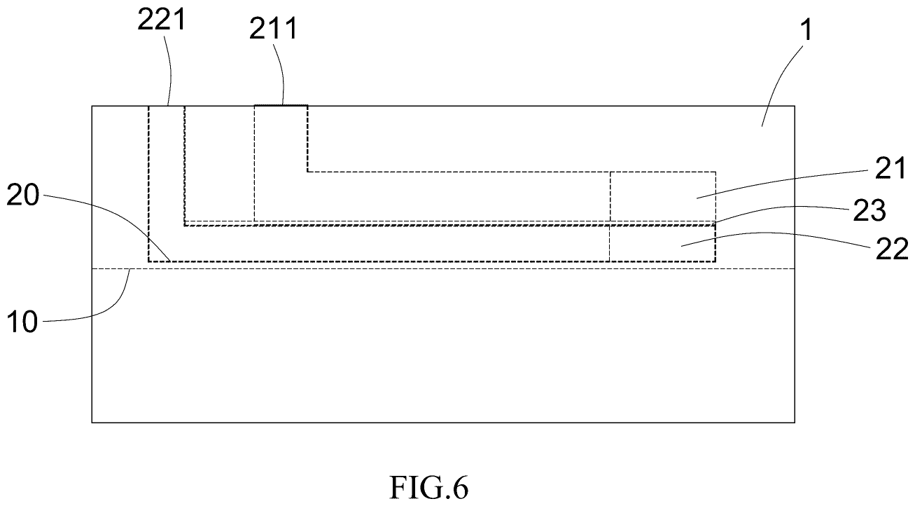

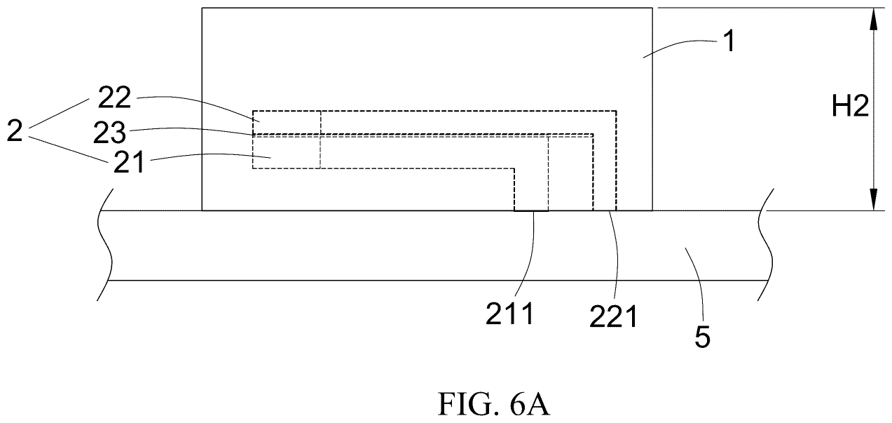

A body 1 is defined with a first surface 10 (as illustrated in FIG. 6). The body 1 can either be an assembled type or an integral type formed by hot pressing or cold pressing iron powder, depending on the design requirements and application scenarios. When the body 1 is of the assembled type, it can be separated into a base portion 11 and a cover portion 12. The base portion 11 serves as a support structure for carrying and securing other components. The cover portion 12 can be placed on the base portion 11 to provide electromagnetic shielding and mechanical protection, safeguarding the internal components from physical damage and environmental factors. The body 1 may also be designed with heat dissipation features to enhance the filter's thermal performance. In other words, at least one heat dissipating piece 13 may be provided on the exterior of the body 1 (as illustrated in FIG. 5 and FIG. 5A) to improve heat dissipation efficiency. This helps ensure the filter remains stable during high-power or high-frequency operation, preventing overheating that could affect performance or lifespan. The advantage of the assembled type is ease of maintenance and replacement—it allows damaged parts to be replaced individually without needing to replace the entire unit. Additionally, the cover portion 12 can be swapped out as needed to adjust the level of electromagnetic shielding or thermal performance. In contrast, the integral type has a one-piece body 1 that is not separable. Its advantage lies in its compact structure, which reduces the risk of mechanical loosening or environmental interference, thereby enhancing reliability.

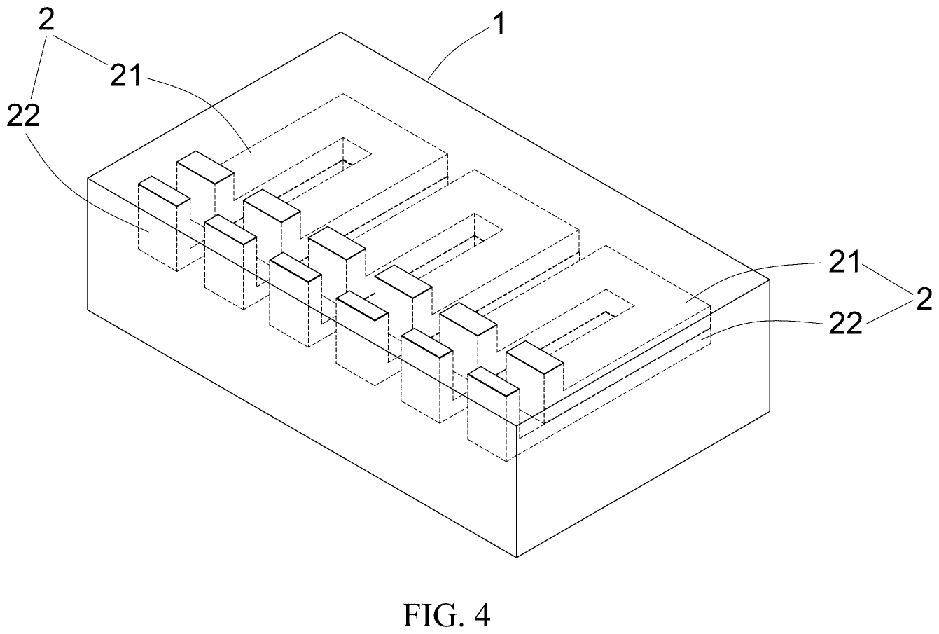

At least one coil assembly 2 is defined with a second surface 20. The coil assembly 2 is enclosed in the body 1, with the second surface 20 parallel to the first surface 10. The coil assembly 2 includes a first coil 21 and a second coil 22, with the first coil 21 stacking on top of the second coil 22. Two ends of the first coil 21 are bent perpendicularly to form first terminals 211, and two ends of the second coil 22 are bent perpendicularly to form second terminals 221. The first terminals 211 and second terminals 221 are extend in the same direction. An insulator 23 is positioned between the first coil 21 and the second coil 22. The first coil 21 and second coil 22 may be flat coils. When there is more than one coil assembly 2, they are arranged laterally with equal spacing. As shown in FIG. 1, the number of coil assemblies 2 may be two—each containing one first coil 21 and one second coil 22—or, as shown in FIG. 4, three coil assemblies 2—each with one first coil 21 and one second coil 22. However, the number is not limited to these examples.

When the first and second coils 21 and 22 are flat coils, the insulator 23 commonly used between them is typically one of the following materials: plastic materials (such as polyvinyl chloride (PVC) or polyethylene (PE)), rubber, ceramic, or glass.

In practical implementation, the body 1 can be fabricated through pressing magnetic materials such as ferrite or metal alloy materials (e.g., Fe—Si alloy, Fe—Ni alloy). If ferrite is used for the body 1, high-temperature sintering is required to enhance its magnetic properties and mechanical strength. If a metal alloy material is used, low-temperature sintering or resin bonding molding may be employed, and metal electrodes may be formed on the body 1.

The fabrication of the at least one coil assembly 2 can be carried out using precision stamping or laser cutting techniques to cut flat copper wire according to the design dimensions, thereby forming the first coil 21 and the second coil 22. The surface of the second coil 22 may be coated with the insulator 23 (such as a PI film or an electroplated insulating layer). The first coil 21 is then stacked on top of the second coil 22, with both ends of the first coil 21 bent and extended to form first terminals 211, and both ends of the second coil 22 bent to form second terminals 221. The first coil 21 and second coil 22 are placed inside the body 1, and the first terminals 211 and second terminals 221 are soldered to the metal electrodes on the body 1 to ensure stable electrical connection.

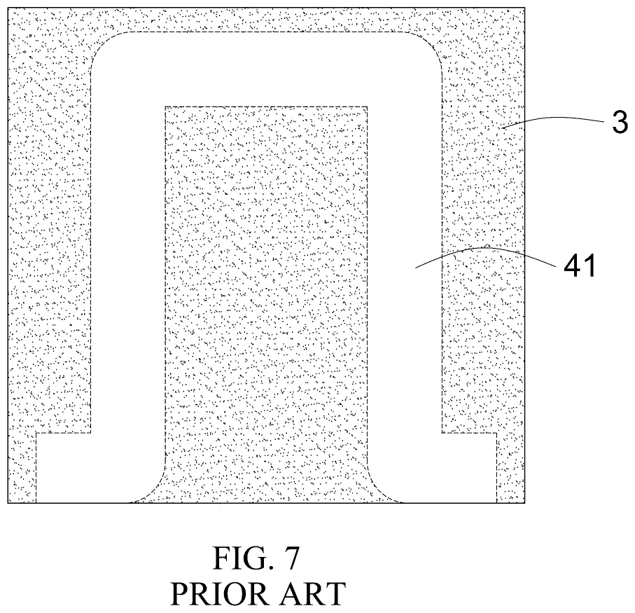

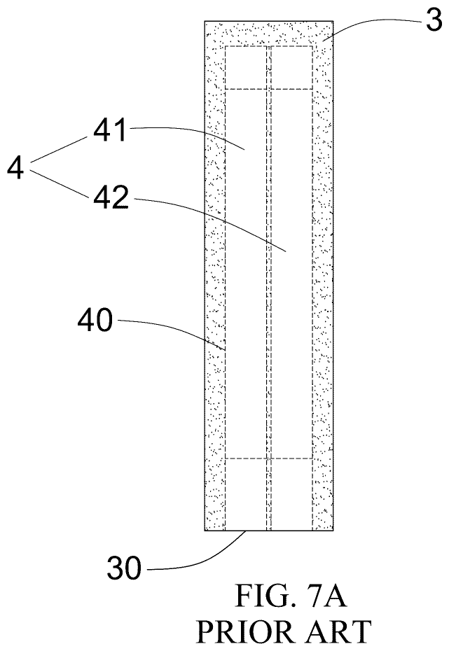

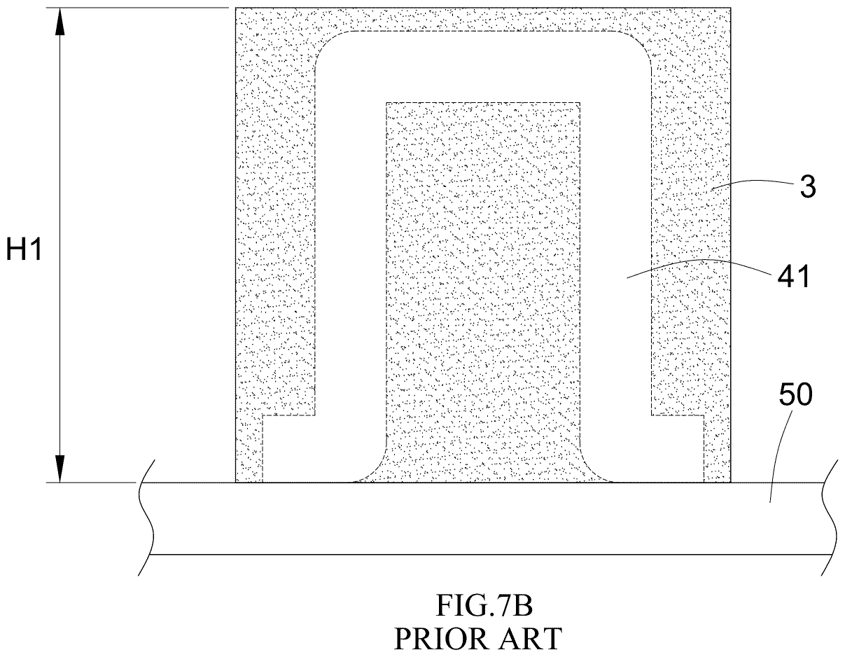

As shown in FIG. 6A, since the coil assembly 2 of the filter in the present embodiment is arranged laterally in the body 1, the overall height H2 of the filter when installed on the circuit board 5 is relatively low. In contrast, as shown in FIGS. 7A and 7B, the coil assembly 4 of a conventional filter is arranged vertically in the body 3, resulting in a higher overall height H1 when the filter is installed on the circuit board 50. Therefore, the present invention's lateral arrangement of the coil assembly 2 which involves stacked first coil 21 and second coil 22 is able to achieve a lower overall height, meeting the requirements for a slim or low-profile design.

TABLE 1

| | Input | | | | Saturation | 30% Inductance | | | | | | | |
|---|---|---|---|---|---|---|---|---|---|---|---|---|---|
| | Inductance | | | | Current [A] | Drop | Coupling | | | | | | |
| | [nH] | | DC Resistance [mΩ] | | L1-2 | L1-2 | Coefficient | Dimension [mm] | | | | | |
| | pri | Sec | pri | sec | 25 °C | 125 °C | L1-2, L4-3 | Length | | Width | | Height | |
| Sample | typ. | typ. | typ. | typ. | typ. | typ. | K12 = K21 | typ. | max. | typ. | max. | typ. | max. |

| | | | | | | | | |
|---|---|---|---|---|---|---|---|---|
| Sample 1 | 140.4 | 167.4 | 0.24 | 0.58 | 80.0 | 80.0 | 0.80 | 12.60-7.50-4.45- |
| Sample 2 | 141.0 | 138.0 | 0.23 | 0.55 | 52.0 | 40.0 | 0.98 | 12.60-7.50-4.45- |

As shown in Table 1, Sample 1 is a conventional filter, while Sample 2 is a filter according to the present embodiment. This table compares the performance of both under the same dimensions. The results show that Sample 1 has a higher saturation current, indicating a greater load-handling capability, which in turn enhances the reliability of the filter. A higher saturation current helps prevent overheating or damage caused by excessive current, making the filter more stable and reliable, and capable of operating for extended periods under more extreme conditions without performance degradation.

TABLE 2

| Bias Current | Average | Inductance Variation |
|---|---|---|
| [A] | Inductance Value | Rate [%] |
| 0.1 | 140.29 | 100.0% |
| 10.1 | 142.90 | 101.9% |
| 20.1 | 144.10 | 102.7% |
| 30.1 | 143.30 | 102.1% |
| 40.1 | 139.73 | 99.6% |
| 50.1 | 128.52 | 91.6% |
| 60.1 | 91.35 | 65.1% |
| 70.1 | 39.58 | 28.2% |
| 80.1 | 21.54 | 15.4% |
| 90.1 | 17.32 | 12.3% |
| 100 | 16.47 | 11.7% |

Table 2 above lists the test data of the conventional filter. As the bias current increases, the average inductance value becomes relatively unstable.

TABLE 3

| Bias Current | Average | Inductance Variation |
|---|---|---|
| [A] | Inductance Value | Rate [%] |
| 0 | 142.73 | 100.0% |
| 10 | 140.47 | 98.4% |
| 20 | 136.05 | 95.3% |
| 30 | 131.06 | 91.8% |
| 40 | 125.71 | 88.1% |
| 50 | 119.90 | 84.0% |
| 60 | 113.45 | 79.5% |
| 70 | 106.73 | 74.8% |
| 80 | 99.44 | 69.7% |
| 90.1 | 91.95552 | 64.4% |
| 100 | 84.0063 | 58.9% |

Table 3 above lists the test data of a filter according to the present embodiment. As the bias current increases, the average inductance value remains stable without degradation.

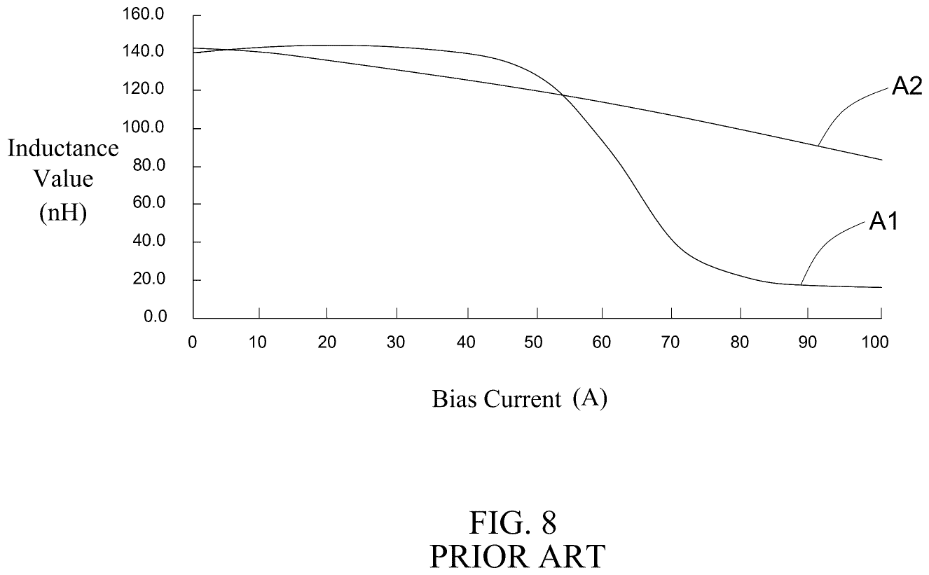

As shown in FIG. 8, curve A1 represents the conventional filter, where the average inductance value becomes relatively unstable as the bias current increases. Curve A2 represents the filter of the present embodiment, where the average inductance value remains stable and does not degrade as the bias current increases.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A filter, comprising:
a body defined with a first surface; and
at least one coil assembly defined with a second surface, where the at least one coil assembly is enclosed in the body with the second surface parallel to the first surface;
wherein the at least one coil assembly comprises a first coil, a second coil, and an insulator; two ends of the first coil are bent to form first terminals, two ends of the second coil are bent to form second terminals; the first terminals and second terminals are extended in a same direction; and the insulator is configured between the first and second coils with the first coil stacking above a top side of the second coil.

2. The filter according to claim 1, wherein the first and second coils are flat coils.

3. The filter according to claim 1, wherein at least one heat dissipating piece is configured on the body's exterior.

4. The filter according to claim 1, wherein, when there are two or more coil assemblies, the coil assemblies are arranged laterally with equal spacing.

5. The filter according to claim 1, wherein the body comprises a base portion and a cover portion; the at least one coil assembly is mounted on the base portion; and the cover portion is placed on the base portion sealing the at least one coil assembly.
